(19) United States
(12) Patent Application Publication
(10) Pub. No.: US 2011/0140290 A1
(43) Pub. Date: Jun. 16, 2011

(54) CHARGE FORMING DEVICE AND VALVE FOR THE SAME

(75) Inventors: Naoya Kumagai, Tokyo (JP); Tetsuya Takahashi, Tokyo (JP)

(73) Assignee: Walbro Japan Limited, Tokyo (JP)

(21) Appl. No.: 12/692,315

(22) Filed: Jan. 22, 2010

(30) Foreign Application Priority Data
Dec. 10, 2009 (CN) 200910254157.6

(51) Int. Cl. F02M 9/127; F16K 31/44

(52) U.S. Cl. 261/66; 251/231

(57) ABSTRACT

One implementation of a carburetor may have a fuel bowl in which a supply of fuel is received for delivery from the carburetor to an engine, and may include a valve rotatably supported by a body, an operating lever coupled to the valve, and a stopper. The operating lever may move the valve between a running position in which fuel flows through the valve in a first direction and into the fuel bowl, a stop position in which fuel does not flow either into or out of the fuel bowl through the valve, and a drainage position in which fuel flows in a second direction out of the fuel bowl through the valve. The stopper may be moveable between a non-permissive state in which the operating lever is not permitted to move in a first direction from one of the running position and the stop position to the other position, and a permissive state in which the operating lever is allowed to move in the first direction.

### CROSS-REFERENCE TO RELATED PATENT(S)

This application claims priority from Chinese Patent Application No. 200910254157.6 filed Dec. 10, 2009, the contents of which is hereby incorporated by reference.

### TECHNICAL FIELD

The present disclosure relates generally to a charge forming device, such as a carburetor, and a valve disposed in fuel flow path between a fuel tank and a charge forming device.

### BACKGROUND

Carburetors may be used to supply a combustible fuel and air mixture to an engine to support operation of the engine. So-called float bowl carburetors may include a bowl in which a supply of fuel is maintained. The fuel in the float bowl may be open to the atmosphere, such as through a vent, and undesirable hydrocarbon emissions may occur if the float bowl is full of fuel when the engine is not operating. Because the float bowl may be automatically replenished when its fuel level drops, the float bowl may remain essentially full even when fuel evaporates during periods when the engine is not operating. Some float bowl carburetors include a drain through which fuel may be removed from the float bowl chamber when the engine is not operating.

### SUMMARY OF THE DISCLOSURE

One implementation of a carburetor may have a fuel bowl in which a supply of fuel is received for delivery from the carburetor to an engine, and may include a valve rotatably supported by a body, an operating lever coupled to the valve, and a stopper. The operating lever may move the valve between a running position in which fuel flows through the valve in a first direction and into the fuel bowl, a stop position in which fuel does not flow either into or out of the fuel bowl through the valve, and a drainage position in which fuel flows in a second direction out of the fuel bowl through the valve. The stopper may be moveable between a non-permissive state in which the operating lever is not permitted to move in a first direction from one of the running position and the stop position to the other position, and a permissive state in which the operating lever is allowed to move in the first direction.

One implementation of a fuel control valve may include a valve rotatably supported by a body, an operating lever coupled to the valve and a stopper. The operating lever may be moveable between a running position in which fuel flows through the valve in a first direction, a stop position in which fuel does not flow through the valve, and a drainage position in which fuel flows through the valve in a second direction. The stopper may be moveable between a non-permissive state in which the operating lever is not permitted to move in a first direction to the drainage position, and a permissive state in which the operating lever is allowed to move in the first direction to the drainage position.

### BRIEF DESCRIPTION OF THE DRAWINGS

The following detailed description of exemplary embodiments and best mode will be set forth with reference to the accompanying drawings, in which:

FIG. 1 is a front view of a carburetor having one embodiment of a control valve;

FIG. 2 is a side view of the carburetor of FIG. 1;

FIG. 3 is a cross-sectional view taken along line III-III of FIG. 1;

FIG. 4 is a plan view of a bottom of a body that may be used in the carburetor depicted in FIG. 1;

FIG. 5 is a plan view of a seal in the carburetor of FIG. 1;

FIG. 6 is a cross-sectional view taken along line A-B-C-D-E-F of FIG. 5;

FIG. 7 is a cross-sectional view illustrating an operating lever of the carburetor of FIG. 1 positioned in its running position;

FIG. 8 is a plan view of the control valve in the carburetor of FIG. 7;

FIG. 9 is a cross-sectional view taken along a line VIII-VIII of FIG. 8;

FIG. 10 is a view illustrating the positional relationship between the operating lever and a groove disposed in the control valve;

FIG. 11 is a cross-sectional view illustrating the operating lever of the carburetor of FIG. 1 positioned in its stop position;

FIG. 12 is a plan view of the control valve in the carburetor of FIG. 11;

FIG. 13 is a cross-sectional view taken along a line XII-XII of FIG. 12;

FIG. 14 is a view illustrating the positional relationship between the operating lever and a groove disposed in the control valve;

FIG. 15 is a cross-sectional view illustrating the operating lever of the carburetor of FIG. 1 positioned in its drainage position;

FIG. 16 is a plan view of a control valve in the carburetor of FIG. 15;

FIG. 17 is a cross-sectional view taken along a line XVI-XVI of FIG. 16;

FIG. 18 is a view illustrating the positional relationship between the operating lever and a groove disposed in the control valve;

FIG. 19 is a cross-sectional view showing the operating lever moved with a stopper pin of the control valve of FIG. 13 being pressed;

FIG. 20 is a view illustrating the positional relationship between the operating lever and a groove disposed in the control valve;

FIG. 21 is a cross-sectional view showing the stopper pin pressed by an inclined surface of the control valve depicted in FIG. 13 that abuts against the stopper pin; and

FIG. 22 is a view illustrating the positional relationship between the operating lever and a groove disposed in the control valve.

### DETAILED DESCRIPTION OF PRESENTLY PREFERRED EMBODIMENTS

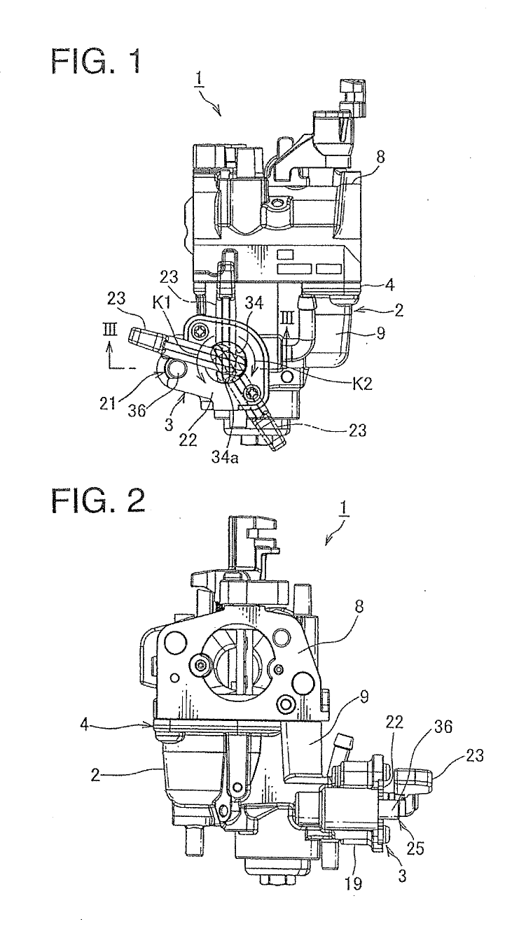

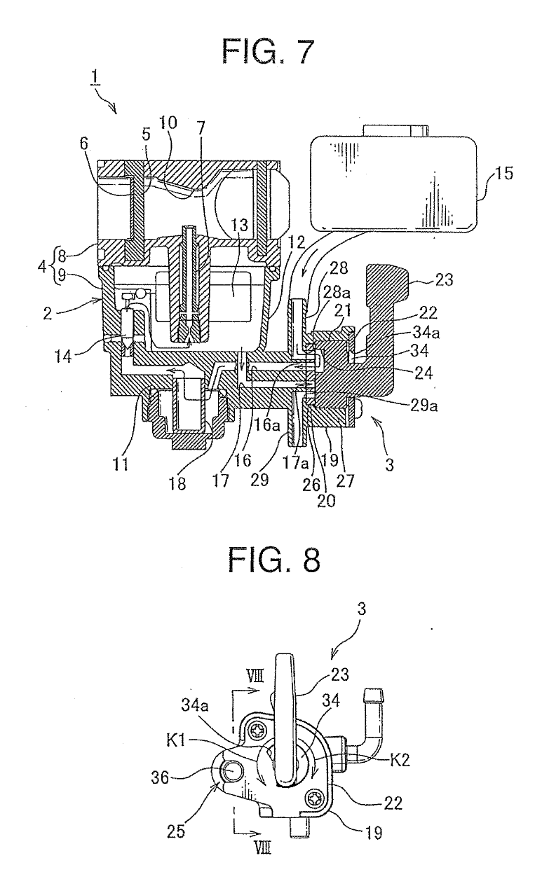

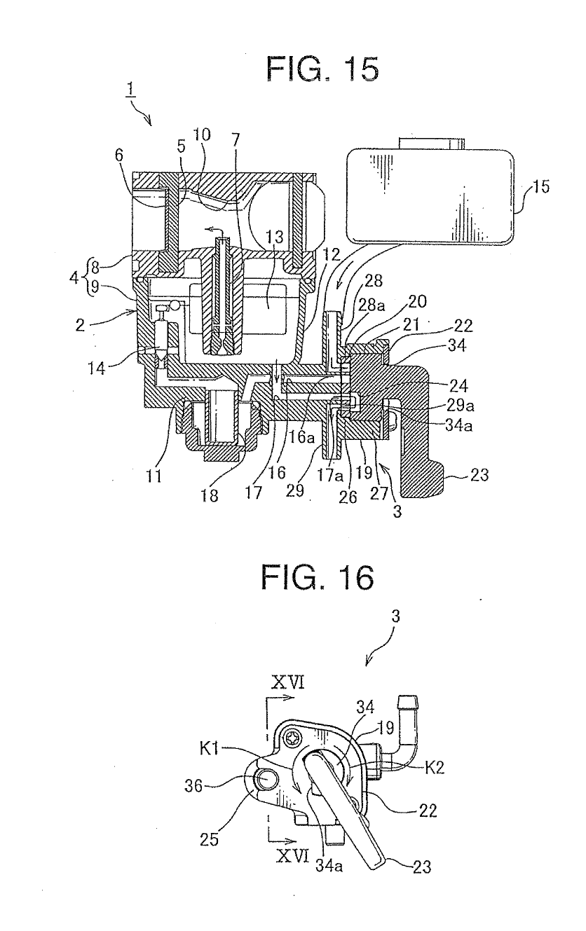

Referring in more detail to the drawings, FIGS. 1 and 2 illustrate a carburetor including one implementation of a control valve. A fuel and air charge forming device, such as a float bowl type carburetor, may have a float bowl body 2 and a control valve 3 (sometimes called a refueling valve) that controls fuel flow into and out of the float bowl body 2. The carburetor 1 may have a main body 4 including the float bowl body 2 and a throttle valve body 8 that, in use, is coupled to an intake manifold (not shown). The carburetor 1 may also have a throttle shaft 5, a throttle valve 6 carried by the shaft 5, and a fuel supply nozzle 7, as shown in FIGS. 7, 11, and 15.

The throttle valve body 8 may have a fuel and air mixing passage in which the throttle valve 6 is arranged to control fluid flow therethrough. The fuel and air mixing passage may communicate with an intake manifold (not shown) mounted to a small-scale generalized internal combustion engine, and may include a venturi portion 10. The float bowl body 2 may define a fuel chamber 9 or float bowl having a bottom wall 11, and a side wall 12 extending from the outer edge of the bottom wall 11 and, preferably, being formed in the shape of a bowl or closed-end cylinder. The float bowl 9 may be disposed such that open end of the side wall 12 is covered by the throttle valve body 8. The float bowl 9 has an inner volume into which fuel is supplied, and may have a float 13 disposed therein and floating on liquid fuel. A needle valve 14 is driven by movement of the float between a fuel supply mode in which fuel is supplied into the float bowl 9 and a shut-off mode in which the supply of fuel into the float bowl 9 is stopped.

The float bowl 9 may have a fuel supply passage 16 opening into the interior of the float bowl 9 and being configured to allow liquid fuel to flow through the control valve 3 from a fuel tank 15 to the float bowl 9. The float bowl 9 may also have a fuel discharge passage 17 opening into the interior of the float bowl 9 and being configured to permit liquid fuel in the float chamber 9 to be discharged out of the carburetor 1. A filter 18 may be disposed at the bottom 11 of the float bowl 9 so as to remove contaminants from liquid fuel flowing through the fuel supply passage 16.

The carburetor 1 is provided for supplying liquid fuel from the float bowl 9, through the fuel supply nozzle 7 and into the fuel and air mixing passage (such as in the venturi portion 10) where the fuel is mixed with air to supply a mixture of liquid fuel and air to an engine. Furthermore, the throttle valve 6 can be selectively and progressively opened and closed by rotation of the throttle shaft 5 to effectively control the flow rate of the mixture of liquid fuel and air to be supplied to the engine.

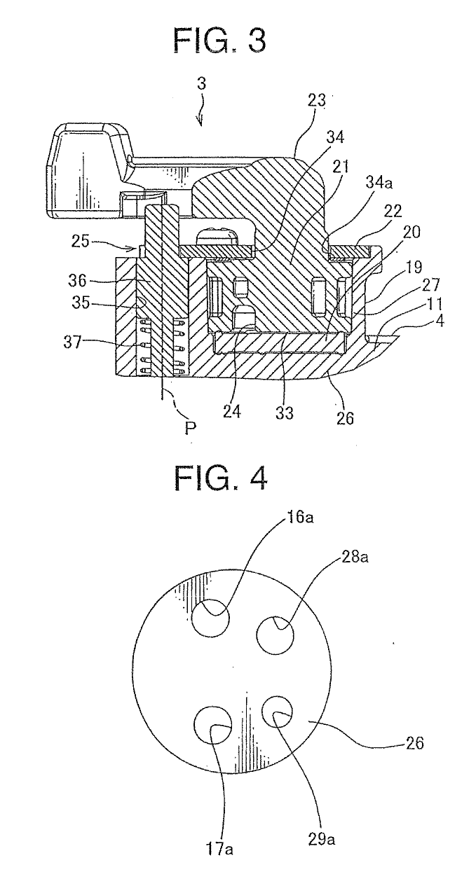

With reference to FIG. 3, the control valve 3 has a body 19, a seal 20, a valve head 21, a cover 22, an operating lever 23, a groove 24, and a pushrod 25 that may function as a stopper. The body 19 may be separately or integrally formed with the body 4 of the carburetor 2. The body 19 may have a generally open bottom 26 coupled with the float bowl body 2, and a side wall 27 extending from the outer edge of the bottom 26 to define a chamber or pocket in which the valve head 21 is received. For example, with reference to FIG. 3, the bottom 26 of the body 19 may be disposed such that it is perpendicular to the fuel bowl bottom 11. The side wall 27 may extend outwardly from the outer edge of the bottom 26 generally along the fuel bowl bottom wall 11. In other words, the side wall 27 may project outward from the body 4 of the carburetor 1.

As shown in FIGS. 4 and 7, the bottom 26 communicates with fuel supply passage 16, the fuel discharge passage 17, a fuel fitting 28 coupled to the fuel tank 15, and a drain or drainage passage 29 that communicates with the outside of the carburetor 1. In other words, the fuel supply passage 16, the fuel discharge passage 17, the fuel fitting 28, and the drainage passage 29 respectively have corresponding ports or openings into the body including a first opening 16a, a second opening 17a, a third opening 28a and a fourth opening 29a all of which open into the bottom 26 of the body 19.

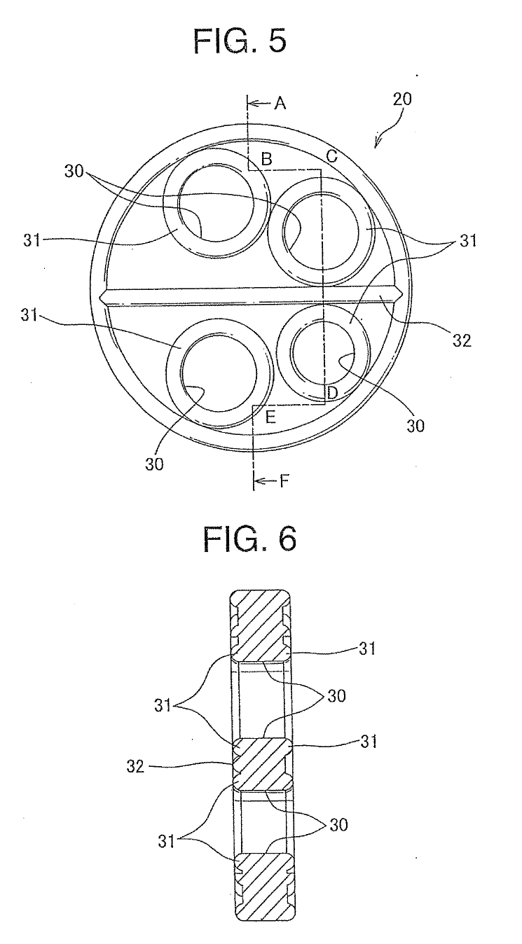

The seal 20 may be generally formed of elastic synthetic resin, such as rubber, and may be formed in the shape of a thin disc. As shown in FIG. 3, the seal 20 may be attached to or received in the body 19 such that it is disposed on or over the bottom 26 of the body 19. Furthermore, as shown in both FIGS. 5 and 6, the seal 20 may have a plurality of through-holes (for example, four through-holes 30 shown in FIG. 5) communicating with the fuel supply passage 16, the fuel discharge passage 17, the fuel fitting 28 and the drainage passage 29. The seal 20 may also have a circular rib 31 projecting from the circumference of the through-hole 30 (hereinafter referred to as the “first rib”), and an approximately linear rib 32 disposed between the first opening 16a and the second opening 17a, and also between the third opening 28a and the fourth opening 29a (hereinafter referred to as the “second rib”). These ribs 31, 32 may come in contact with the bottom 33 of the valve head 21, which will be described in detail, to form a liquid tight seal structure therebetween, and to prevent or inhibit leakage of liquid between the ribs 31, 32 and the bottom 33 of the valve head 21.

The valve head 21 may be formed in the shape of a somewhat cylindrical disc. The outer diameter of the valve head 21 substantially corresponds to the inner diameter of the pocket defined by the body 19, and the valve head 21 may be received within the pocket. Furthermore, the bottom 33 of the valve head 21 may be in close contact with the ribs 31, 32 of the seal 20, and is free to rotate within the pocket of the body 19.

The operating lever 23 may have one end coupled to the upper surface of the valve head 21, and may be an arm-shaped structure extending radially outwardly from the valve head 21 so that the free end of the lever 23 is accessible from the outside carburetor. The operating lever 23 may be integrally formed with the valve head 21. The operating lever 23 is rotatable together with the valve head 21. The lever 23 and valve head 21 can be switched among a running position which is depicted with a dashed-dotted line in FIG. 1 (— - —), a stop position which is depicted with a solid line in FIG. 1, and a drainage position which is depicted with a dashed, two dotted line in FIG. 1 (— - - —).

The cover 22 may be formed in the shape of a thin plate, and may be attached to the side wall 27 overlying the valve head 21. A hole 34 may be provided in the cover 22 through which the operating lever 23 extends. The inner edge 34a of the hole 34 allows the operating lever 23 to rotate or move in a direction from the running position via the stop position to the drainage position (hereinafter referred to as a “first direction”), as well as to rotate or move in a direction from the drainage position via the stop position to the running position (hereinafter referred to as a “second direction”). Referring to FIG. 1, the first direction is designated by arrow “K1”, and the second direction is designated by arrow “K2”. In addition, the inner edge 34a of the hole 34 may be configured to prevent the operating lever 23 from rotating or moving in the first direction from the drainage position toward the running position, as well as in the second direction from the running position toward the drainage position. In the implementation shown, the hole is not completely circular and thereby provides a stop surface engageable by the lever 23 to limit rotation of the lever 23 and the valve head 21.

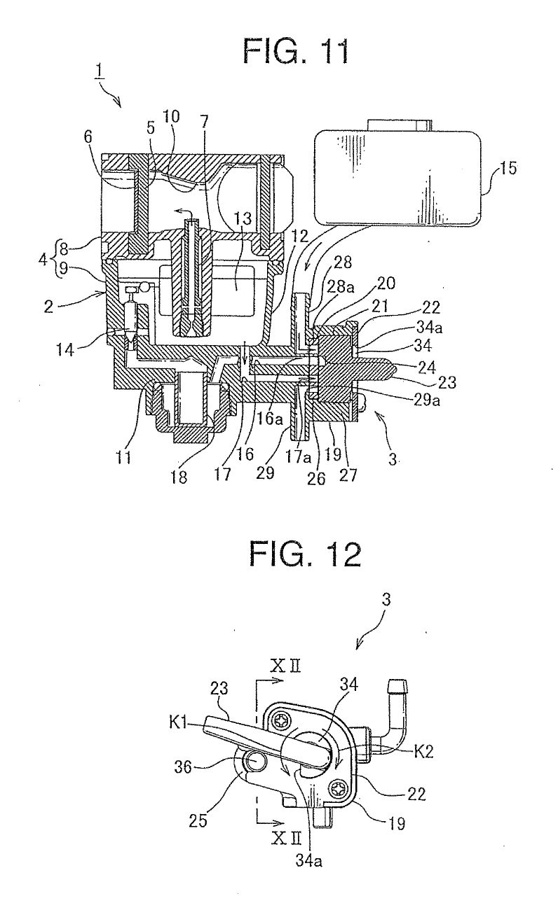

As shown in FIGS. 7 and 10, the groove 24 may be formed in the bottom 33 of the valve head 21. The groove 24 may be curved or arcuate, and may extend circumferentially in the bottom 33 of the valve head 21. When the operating lever 23 is in the running position, the groove 24 interconnects or allows for communication between the third opening 28a (of the fuel fitting 28) and the first opening 16a (of the fuel supply passage 16), as shown in FIGS. 7 and 10. When the operating lever 23 is in the stop position, the groove 24 only communicates with the first opening 16a, as shown in FIGS. 11 and 14. When the operating lever 23 is in the drainage position, the groove 24 interconnects or allows for communication between the second opening 17a (of the fuel discharge passage 17) and the fourth opening 29a (of the drainage passage 29). Via the groove 24 the control valve 3 enables liquid fuel to be supplied from the fuel tank 15 into the float bowl 9, when the operating lever 23 is in the running position. Also, via the groove 24 the control valve 3 can stop both the supply of liquid fuel from the fuel tank 15 into the float bowl 9 and the discharge of the liquid fuel from the float bowl 9, when the operating lever 23 is in the stop position. Further, via the groove 24 liquid fuel in the float bowl 9 can be discharged through the drainage passage 29 out of the carburetor 1, when the operating lever 23 is in the drainage position.

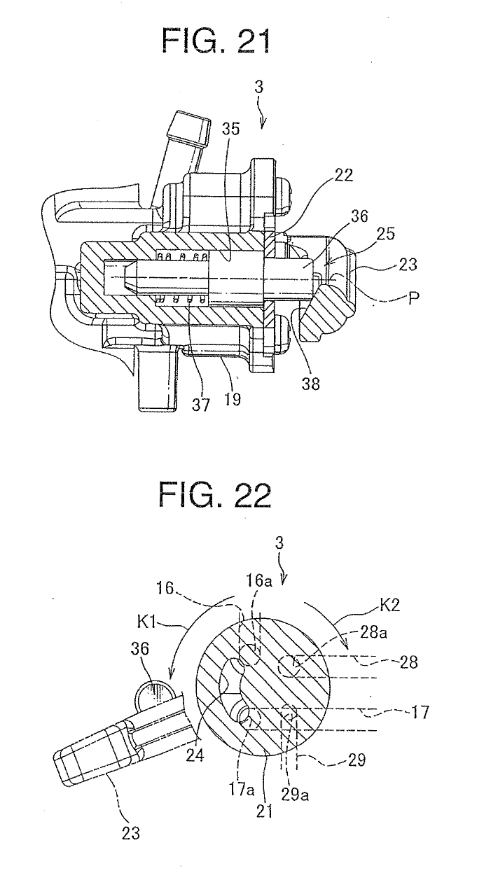

With reference to FIG. 3, the pushrod 25 has a pin-receiving portion 35, a stopper pin 36, a coil spring 37 acting as a pushing or biasing member, and an inclined cam surface 38 that may be provided on the lever 23 (for more detail, see FIG. 21). The pushrod 25 may selectively engage the operating lever 23 to limit or control at least certain movements of the operating lever.

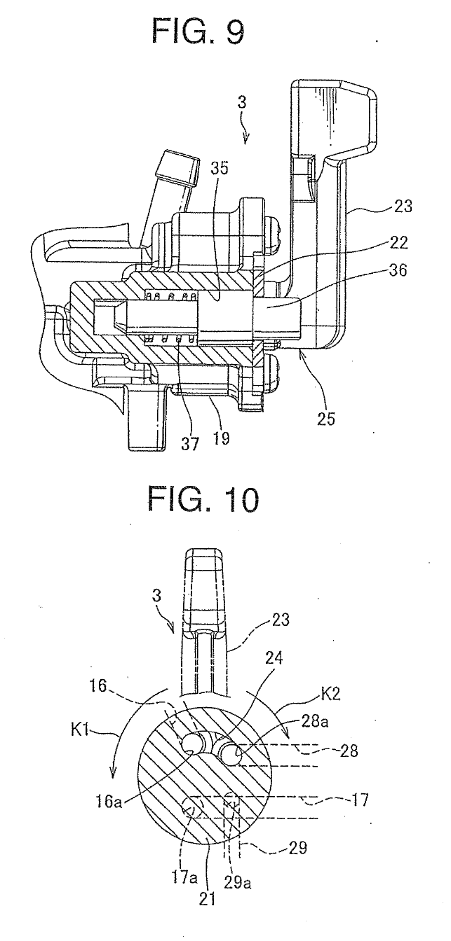

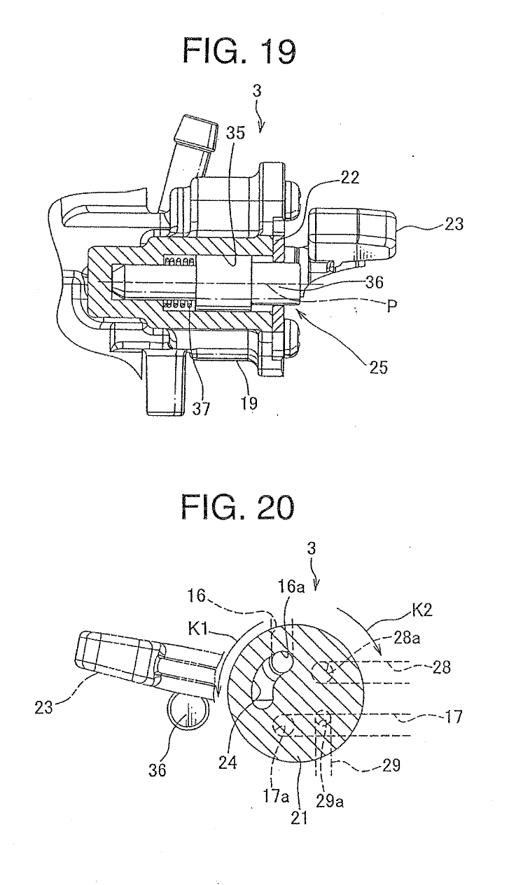

The pin-receiving portion 35 may be disposed in the body 19, and have a shaft parallel to the axis of the valve head 21. The pin-receiving portion 35 may be formed in the shape of a closed-end cylinder. The stopper pin 36 may be cylindrical with an outer diameter varying in a stepwise fashion, and have one end portion received within the pin-receiving portion 35. The one end portion of the stopper pin 36 may be slidably received within the pin-receiving portion 35 along the axis P, and the other end of the stopper pin 36 may extend from the body 19. Also, the cover 22 may retain the stopper pin 36 within the pin-receiving portion 35. The stopper pin 36 has extended and retracted positions. When the stopper pin 36 is in its extended position, it may come in contact with the operating lever 23 thus preventing the operating lever 23 from moving in at least certain circumstances. On the other hand, when the stopper pin 36 is in its retracted position in which the stopper pin 36 is more fully received in the pin-receiving portion 35 of the body 19, it does not interfere with the operating lever 23 thus allowing the operating lever 23 to move. The former is referred to as a “non-permissive state” (for example, see FIG. 9), and the latter is referred to as a “permissive state” (for example, see FIG. 19). Hence, in this implementation, the non-permissive state is produced by the stopper pin 36 in its extended position, and the permissive state is produced by the stopper pin 36 in its retracted position. When in its extended position, the stopper pin 36 may extend outwardly from the carburetor body so that the pin can be manually moved from its extended position toward its retracted position, such as by pushing on the pin.

The coil spring 37 may be disposed between the pin-receiving portion 35 and the stopper pin 36, and may be configured to exert a force on the stopper pin 36 to yieldably bias the stopper pin 36 toward its extended position. The pin 36 may be slidably displaced against the force of spring 37 from its extended position toward its retracted position.

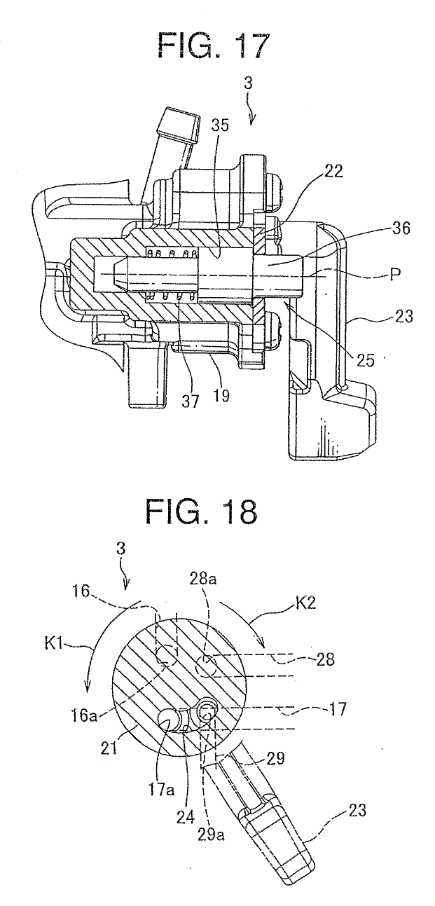

Under the force of the spring 37, the pin 36 is normally in its extended position. In the extended position, the pin will engage the lever 23 to prevent movement of the lever from the stop position to the drainage position. This can prevent unintended drainage of the fuel bowl 9. When drainage is intended, the pin can be depressed to its retracted position against the force of the spring 37 so that the lever 23 can be rotated past the pin from the stop position to the drainage position as shown in FIGS. 16-18 and 20. To move the lever out of the drainage position to the stop position, the lever 23 need only be rotated in the second direction and the inclined cam surface 38 will engage and increasingly retract the pin as the lever 23 is rotated to permit the lever to rotate past the pin. Accordingly, the pin 36 need not be separately retracted before rotating the lever 23 from the drainage to the stop position. Otherwise, the pin 36 and lever 23 may be arranged so that the pin does not interfere with movement between the running and stop positions. With the stop surface of the cover, the lever 23 can be moved only to the stop position from the running position, and only to the stop position from the drainage position. From the stop position, the lever 23 can be rotated freely to the running position. And from the stop position the lever 23 can be rotated to the drainage position only after the pin 36 has first been moved to its retracted position. In this way, unintended movement of the lever 23 to the drainage position, in both the first and second directions, can be prevented.

Referring to FIG. 21, the cam surface 38 of the lever 23 is disposed such that it can abut against the stopper pin 36 during the movement of the operating lever 23 in the second direction from the drainage position. The inclined surface 38 is incrementally inclined toward the drainage position relative to the axis P of the stopper pin 36.

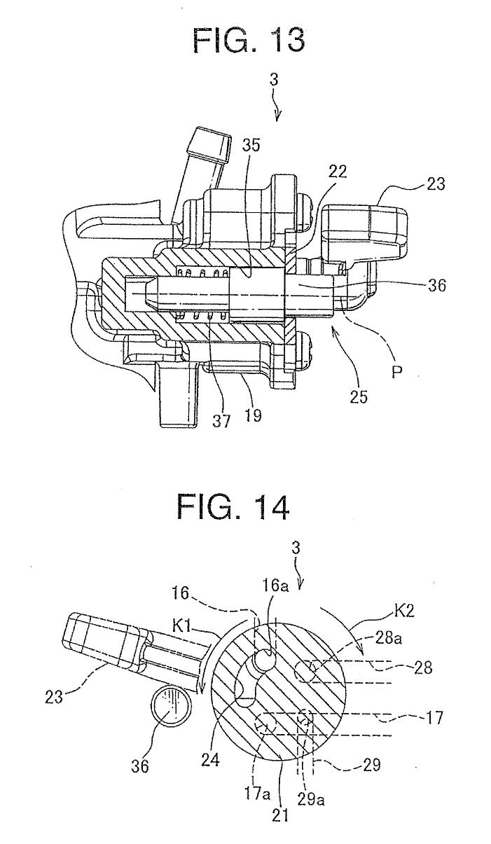

In use, the operating lever 23 is moved to the running position so that liquid fuel may be supplied from the fuel tank 15 into the float bowl 9 while an engine is operating, as shown in FIG. 8. The operating lever 23 is moved in the first direction to its stop position when the operation of the engine is stopped, as shown in FIGS. 12 and 13. In this position, since the stopper pin 36 is in its non-permissive state in which the stopper pin 36 is biased to its extended position by the coil spring 37, and the cam surface 38 of the lever does not abut the stopper pin 36, the operating lever 23 cannot freely move in the first direction to its drainage position without first moving the stopper pin 36 to its retracted position, as shown in FIG. 13.

Moreover, with reference to FIGS. 21 and 22, when the operating lever 23 is moved in the second direction out of the drainage position, the cam surface 38 abuts the stopper pin 36, thereby pressing the stopper pin 36 until the stopper pin 36 returns to its permissive state. Accordingly, the operating lever 23 can be moved from the drainage position to the stop or running position without having to separately move the stopper pin 36 to its retracted position.

In this embodiment, the pushrod 25 functions as a stopper to limit rotation of the operating lever 23 in the first direction from the stop position to the drainage position. In this manner, unintended or undesired movement of the operating lever 23 in the first direction to its drainage position can be prevented. Accordingly, unintended or undesired discharge of liquid fuel from the float bowl 9 during the operation of the engine or during refueling will not occur. This may reduce or prevent the discharge of liquid fuel to the atmosphere and, unwanted or sudden stopping of the engine can be effectively prevented.

Furthermore, the seal 20, which is provided for fluid tight seal between the body 19 and the valve head 21, has the first rib 31 disposed around each opening 16a, 17a, 28a, and 29a, and the second rib 32 disposed between the first opening 16a and the second opening 17a and also between the third opening 28a and the fourth opening 29a. With the construction as described previously, liquid fuel can circulate between the liquid supply passage 16 and the liquid discharge passage 17 thus preventing liquid fuel from being externally discharged. Also, liquid fuel in the fuel tank 15 is not allowed to be directly discharged through the drainage passage 29 to the outside.

In accordance with the afore-mentioned embodiment, when the operating lever 23 is moved in the first direction, it would be positioned in the running position, subsequently in the stop position, and subsequently in the drainage position. In accordance with the present invention, the valve head 21 may be separately formed from the operating lever 23. In this case, the valve head 21 may be then attached to the operating lever 23. Moreover, the first direction may correspond to the clockwise direction, and the second direction may correspond to counterclockwise direction, or vice versa.

It is to be understood that the foregoing description is not a definition of the invention but is a description of one or more preferred exemplary embodiments of the invention. The invention is not limited to the particular embodiment(s) disclosed herein but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example”, “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A carburetor having a fuel bowl in which a supply of fuel is received for delivery from the carburetor to an engine, the carburetor comprising:
a valve rotatably supported by a body;
an operating lever coupled to the valve to move the valve between a running position in which fuel flows through the valve in a first direction and into the fuel bowl, a stop position in which fuel does not flow either into or out of the fuel bowl through the valve, and a drainage position in which fuel flows in a second direction out of the fuel bowl through the valve; and
a stopper that is moveable between a non-permissive state in which the operating lever is not permitted to move in a first direction to the drainage position, and a permissive state in which the operating lever is allowed to move in the first direction to the drainage position.

2. The carburetor of claim 1 wherein the stopper includes a pin carried by the body so that the pin is moveable between extended and retracted positions, and a biasing member yieldably biasing the pin toward its extended position, and wherein the pin abuts the operating lever when the pin is in its extended position to prevent movement in the first direction of the valve to the drainage position.

3. The carburetor of claim 1 wherein the stopper includes a cam surface positioned to selectively engage the pin and move the pin from its extended position toward its retracted position when the operating lever is moved in a second direction that is opposite to the first direction.

4. The carburetor of claim 3 wherein the cam surface is carried by the operating lever and permits movement of the operating lever in the second direction when the operating lever is moved in the second direction from the drainage position.

5. The carburetor of claim 1 wherein the body includes a first opening that communicates with a fuel supply passage through which fuel is supplied to the fuel bowl, a second opening that communicates with a fuel discharge passage through which fuel is discharged from the float chamber, a third opening that communicates with a fuel supply, and a fourth opening that communicates with a drain through which fuel may be drained from the fuel bowl, wherein at least one of the valve and the body includes a seal forming a fluid tight seal between the valve and the body, and wherein the seal includes a through-hole communicating with each of the openings, a first rib disposed around the through-hole, and a second rib disposed between the first opening and the second opening, and between the third opening and the fourth opening.

6. The carburetor of claim 1 which also includes a stop surface engageable with the operating lever to prevent rotation of the operating lever from the running position directly to the drainage position and from the draining position directly to the running position.

7. The carburetor of claim 6 wherein the stop surface is provided on a cover that is carried by the body and retains the valve in position relative to the body.

8. The carburetor of claim 7 wherein the stop surface includes a portion of an opening formed in the cover.

9. The carburetor of claim 2 wherein an end of the pin extends outwardly from the body when the pin is in its extended position so that the pin may be manually moved to its retracted position.

10. A fuel control valve, comprising:
a valve rotatably supported by a body;
an operating lever coupled to the valve and moveable between a running position in which fuel flows through the valve in a first direction, a stop position in which fuel does not flow through the valve, and a drainage position in which fuel flows through the valve in a second direction; and
a stopper that is moveable between a non-permissive state in which the operating lever is not permitted to move in a first direction to the drainage position, and a permissive state in which the operating lever is allowed to move in the first direction to the drainage position.

11. The valve of claim 10 wherein the stopper includes a pin carried by the body so that the pin is moveable between extended and retracted positions, and a biasing member yieldably biasing the pin toward its extended position, and wherein the pin abuts the operating lever when the pin is in its extended position to prevent movement in the first direction of the valve to the drainage position.

12. The valve of claim 10 wherein the stopper includes a cam surface positioned to selectively engage the pin and move the pin from its extended position toward its retracted position when the operating lever is moved in a second direction that is opposite to the first direction.

13. The valve of claim 12 wherein the cam surface is carried by the operating lever and permits movement of the operating lever in the second direction when the operating lever is moved in the second direction from the drainage position.

14. The valve of claim 10 which also includes a stop surface engageable with the operating lever to prevent rotation of the operating lever from the running position directly to the drainage position and from the draining position directly to the running position.

15. The valve of claim 14 wherein the stop surface is provided on a cover of the valve that retains the valve in position relative to a body with which the valve is used.

16. The carburetor of claim 15 wherein the stop surface includes a portion of an opening formed in the cover.

17. The carburetor of claim 11 wherein an end of the pin extends outwardly from the body when the pin is in its extended position so that the pin may be manually moved to its retracted position.
